(19) United States
(12) Patent Application Publication
(10) Pub. No.: US 2002/0047784 A1
(43) Pub. Date: Apr. 25, 2002

(54) Bath overflows

(76) Inventor: Andrew Peter Dunnett, Andover (GB)

Correspondence Address: SHERIDAN ROSS PC, 1560 BROADWAY, SUITE 1200, DENVER, CO, 80202

(21) Appl. No.: 09/982,252

(22) Filed: Oct. 16, 2001

(30) Foreign Application Priority Data
Oct. 19, 2000 (GB) 0025733.7
Mar. 6, 2001 (GB) 0105418.8

(51) Int. Cl. G08B 21/00

(52) U.S. Cl. 340/618; 340/612

(57) ABSTRACT

A bath overflow plumbing fitting has a housing having a connecting portion for mating with a complementary connecting portion of a plumbing component of the bath overflow so as to attach the plumbing fitting and plumbing component to a bath and to provide an overflow passageway through the housing into the plumbing component. The fitting is arranged to detect the presence of water in the housing and provide an alarm output in response to such detection, so as to provide a bath alarm that is part of the overflow plumbing, rather than an attachment to it. This facilitates the production of a rugged alarm that does not significantly impede the flow of water through the overflow.

### BACKGROUND TO THE INVENTION

1. Field of the Invention

This invention relates to bath overflows.

2. Description of the Prior Art

Baths are usually fitted with an overflow so that if the bath is overfilled because the user has left the tap(s) running too long, water will tend to be drained off through the overflow rather than spilling over the top of the bath. Sometimes with a newly installed bath, the overflow does not have the ability to take the full flow of water from the taps so that the bath water can still be spilled. Even if the overflow does have the ability to take the full flow of water from the taps, letting water overflow is wasteful. Furthermore, the overflow can become partially or completely blocked with time, for example with hair and deposits that collect particularly in the drain fitting to which the overflow is connected, as a result of which water can be spilled.

There have been many proposals in the past for bath alarms that are actuated when the water in the bath reaches a particular level, but none appears to have met with commercial success. Some of these alarms are attached to the wall of the bath with suckers. Others are hung from the edge of the bath. These alarms are not permanently fitted and in use would tend to get dislodged, forgotten about, or, in the case of a hotel bathroom, stolen.

The overflow of a bath typically has a threaded elbow that protrudes through a hole in the bath, and a grating/nut that is screwed to the elbow to hold it in place, seal it to the bath, and allow water to flow through the grating into the elbow.

Patent document U.S. Pat. No. 5,661,462 describes a bath alarm that is secured as an add-on to the grating by a screw and sounds an alarm when the water level reaches the alarm. A problem with this alarm is that if it is fitted too closely to the grating, it will block or severely restrict the flow of water into the overflow. On the other hand, if it is spaced further from the grating, it is all too easy for the attachment screw to be accidentally bent or broken.

### SUMMARY OF THE INVENTION

The present invention, or at least specific embodiments of it, is concerned with overcoming the above-mentioned problem.

A first aspect of the present invention provides a plumbing fitting for an overflow of a bath, comprising: a housing having a connecting portion for mating with a complementary connecting portion of a plumbing component of the bath overflow so as to attach the plumbing fitting and plumbing component to the bath and to provide an overflow passageway through the housing into the plumbing component; means for detecting the presence of water in the housing; and means for providing an alarm output in response to such detection, so as to provide a bath alarm. It will therefore be appreciated that the bath alarm is part of the overflow plumbing, rather than an attachment to it. This facilitates the production of a rugged alarm that does not significantly impede the flow of water through the overflow.

In one embodiment of the invention, the connecting portion of the housing is internally threaded to receive a complementary externally-threaded portion of the plumbing component projecting through a hole in a wall of the bath. In another embodiment of the invention, the connecting portion of the housing is externally threaded for projecting through a hole in a wall of the bath and being received by a complementary internally-threaded portion of the plumbing component. The size of the threaded connecting portion of the housing is preferably an international or national standard size for overflow plumbing fittings so that it can mate with a standard plumbing component. For example, in the United Kingdom, the threaded connecting portion of the housing may be of the size known as “1 1/2 inches”, or the diameter of the threaded connecting portion of the housing may be nominally 40 mm.

In a further embodiment of the invention, the connecting portion of the housing is adapted to be a push fit with a complementary portion of the plumbing component.

Preferably, the housing has a first housing portion providing the overflow passageway through the bath alarm, and a second sealed housing portion containing the means for providing the alarm output, so as to keep it dry. In this case, the connecting portion is preferably provided to one side of the first housing portion, with the second housing portion being provided to the opposite side of and/or above the first housing portion, so as to provide a compact arrangement. The first housing portion preferably has a circular side wall having at least one perforation to permit water to flow from the bath into the first housing portion.

A second aspect of the invention provides a bath alarm unit that is adapted to form part of the overflow outlet plumbing for a bath, the alarm unit having a sensor that senses when the bath begins to overflow or is about to begin overflowing.

Other aspects of the invention provide such a plumbing fitting in combination with such a complementary plumbing component, and a bath having such a combination.

### BRIEF DESCRIPTION OF THE DRAWINGS

FIG. 1 is a schematic side view of a bath;

FIG. 2 is a front view of a conventional overflow assembly for the bath of FIG. 1;

FIG. 3 is a sectioned side view of the conventional overflow assembly of FIG. 2;

FIG. 4 is a sectioned side view of an overflow assembly forming an embodiment of the invention;

FIG. 5 is a sectioned front view of the overflow assembly of FIG. 4;

FIG. 6 is a non-sectioned side view of the overflow assembly of FIGS. 4 and 5; and

FIG. 7 is an electrical circuit diagram for the overflow assembly of FIGS. 4 to 6.

### DETAILED DESCRIPTION OF THE PREFERRED EMBODIMENT

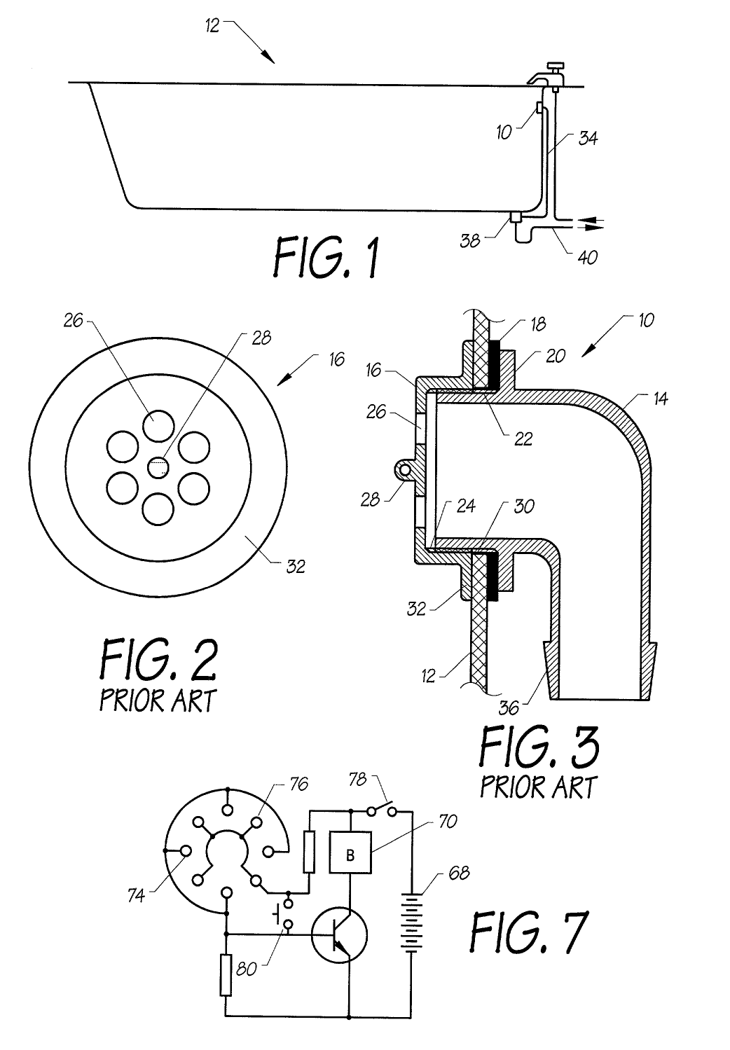

A specific embodiment of the present invention will now be described, purely by way of example, with reference to the drawings. Referring to FIGS. 1 to 3, a conventional overflow assembly 10 for a bath 12 comprises a plastic elbow 14, plastic grating/nut 16 and rubber sealing washer 18. One arm of the elbow 14 has a flange 20 and an externally-threaded portion 22 beyond the flange 20. The grating/nut 16 has a top-hat section with an internally-threaded portion 24. The central portion of the grating/nut 16 has an array of perforations 26 and a central lug 28 to which a bath plug chain can be attached. The externally-threaded portion 22 of the elbow 14 passes through a hole 30 in the end wall of the bath 12, with the sealing washer 18 being disposed between the flange 20 and the wall of the bath 12 surrounding the hole 30. The grating/nut 16 is screwed tightly onto the externally-threaded portion 22 of the elbow 14 so that the wall of the bath 12 and the sealing washer 18 are held between the outer portion 32 of the grating/nut 16 and the flange 20 on the elbow 14. One end of a flexible tube 34 is a push fit onto the other arm 36 of the elbow 14, and the other end of the flexible tube 34 is a push fit onto a drain fitting 38 of the bath 12. If the bath 12 is overfilled, water flows through the perforations 26 in the grating/nut 16, the elbow 14, the tube 34 and the drain fitting 38 to a drain pipe 40 from the bath 12.

The threaded portions 22,24 of the elbow 14 and grating/nut 16 are a standard size, such as 1½ inch diameter or 40 mm diameter, in accordance with a current national or international standard, such as BS 5254 or BS EN 1451-1 or a similar American standard.

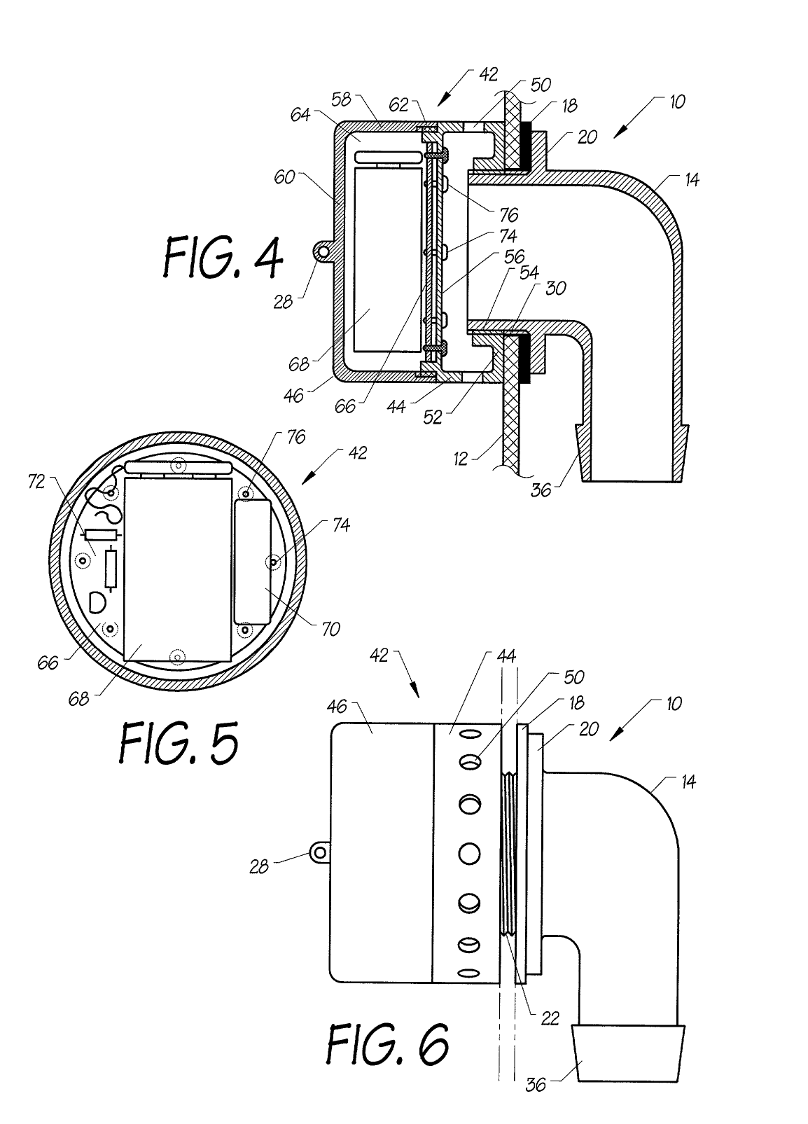

In the embodiment of the invention, the grating/nut 16 of the overflow assembly 10 described above with reference to FIGS. 1 to 3 is replaced by a plumbing fitting 42 as will now be described with reference to FIGS. 4 to 7 so as to provide a bath alarm.

The plumbing fitting 42 has an inner housing 44 for fitting to the threaded portion 22 of the elbow 14, and an outer housing 46. Specifically, the inner housing 44 has a circular side wall 48 formed with an array of perforations 50, an inner end wall 52 formed with a central internally-threaded hole 54 complementary to the threaded portion 22 of the elbow 14, and an outer end wall 56. The outer housing 46 has a circular side wall 58 and an end wall 60, and is releasably secured to the inner housing 44 by threads 62 so as to form a waterproof chamber 64. A lug 28, or other means, is provided on one of the housings 44,46 for attachment of a bath plug chain.

A circuit board 66 and battery 68 are housed in the waterproof chamber 64. The circuit board carries a buzzer or sounder 70 and other electrical components 72, together with a circular array of an even number of electrodes 74,76 which pass through and are bonded to the outer end wall 56 of the inner housing 44. One set of alternate electrodes 74 are connected together, and the other electrodes 76 are also connected together as a set. The electrical components are connected in a circuit as shown in FIG. 7 so that when the space inside the inner housing 44 is dry, the buzzer is off and the circuit does not draw any current from the battery 68. However, when the level of water in the bath 12 rises to a level such that it enters the inner housing through the perforations 50 and such that an adjacent pair of the electrodes (one in each of the two sets) is immersed, the buzzer 70 is switched on. The outer end wall 56 of the inner housing 44 (and/or other portions of the housing 44) is relatively thin to assist in the sound from the buzzer 70 escaping from the alarm unit so as to attract the attention of the user. As the water level rises further, before the user turns off the bath tap(s), the water escapes through the elbow 14. Once the user has turned off the taps, they can drain some water from the bath 12 so that the electrodes 74 are no longer immersed and the buzzer 70 is turned off.

With time, the battery will go flat, but it can then be replaced upon removal of the outer housing 46.

It will be appreciated that many modifications and developments may be made to the plumbing fitting 42 described above. For example, other arrangements of two or more of the electrodes 74 may be employed. Other means for sensing the water level may be employed, such a float which mechanically or magnetically operates a switch. An on-off switch 78 may be provided so that people who enjoy a deep bath can switch the electrical circuit off so that they are not annoyed by the buzzer 70 sounding intermittently with waves in the bath water. Some means for testing or monitoring the battery 68 may be provided, such as a test switch 80 that can be manually operated to turn on the buzzer 70, or a circuit which pulses the buzzer 70 when the battery voltage falls below a predetermined value. Other means of providing an alarm output may be provided, such as a low-power, short range radio transmitter or other form of transmitter that transmits, when the bath overflows, to a receiver carried by the user to cause the receiver to produce an audible alarm signal or to a central alarm system to trigger the alarm system. Other forms of connection of the plumbing fitting 42 to different forms of plumbing component may be provided, such as an externally-threaded portion on the fitting 42 that projects through the hole 30 in the wall of the bath 12 and engages an internally-threaded portion in the plumbing component, or a push-fit portion on the plumbing fitting 42 that engages with a complementary portion on the plumbing component. The plumbing component to which the plumbing fitting 42 is attached may be an elbow 14, some other form of coupling, or the overflow pipe 34 itself. The housing(s) 44,46 of the fitting 42 may be arranged differently. For example, the fitting may be designed so as to have a particular “right way up”, and to have: a water chamber with a water inlet in its underside; a battery chamber in front of the water chamber; and an alarm/circuitry chamber above the water and battery chambers, the alarm/circuitry chamber having a thin upper wall to permit sound to escape from the buzzer 70. In order to enable the fitting 42 to be secured the right way up, a compressible waterproof washer may be provided between the fitting and the wall of the bath around the hole 30. The inner housing 44 may alternatively be formed as first and second parts, with the first part having the internally-threaded hole 54 and being intended to be permanently fitted to the threaded portion 22 of the elbow 14 or the like, and with the second part being releasably connected to the first part, for example with a bayonet fixing or fixing screws. The second part and the remainder of the fitting 42 may then be provided as a sealed disposable unit that is intended to be replaced by a similar unit once the battery 68 has been used up.

It should be noted that the embodiment of the invention has been described above purely by way of example and that many other modifications and developments may be made thereto within the scope of the present invention.

What I claim is:

1. A plumbing fitting for an overflow of a bath, comprising: a housing having a connecting portion for mating with a complementary connecting portion of a plumbing component of the bath overflow so as to attach the plumbing fitting and plumbing component to the bath and to provide an overflow passageway through the housing into the plumbing component; means for detecting the presence of water in the housing; and means for providing an alarm output in response to such detection.

2. A plumbing fitting as claimed in claim 1, wherein the connecting portion of the housing is internally threaded to receive a complementary externally-threaded portion of the plumbing component projecting through a hole in a wall of the bath.

3. A plumbing fitting as claimed in claim 2, wherein the size of the threaded connecting portion of the housing is an international or national standard size for overflow plumbing fittings.

4. A plumbing fitting as claimed in claim 2, wherein the threaded connecting portion of the housing is of the size known as “1½ inches”.

5. A plumbing fitting as claimed in claim 2, wherein the diameter of the threaded connecting portion of the housing is nominally 40 mm.

6. A plumbing fitting as claimed in claim 1, wherein the connecting portion of the housing is externally threaded for projecting through a hole in a wall of the bath and being received by a complementary internally-threaded portion of the plumbing component.

7. A plumbing fitting as claimed in claim 1, wherein the connecting portion of the housing is adapted to be a push fit with a complementary portion of the plumbing component.

8. A plumbing fitting as claimed in claim 1, wherein the housing has: a first housing portion providing the overflow passageway through the housing; and a second sealed housing portion containing the means for providing the alarm output.

9. A plumbing fitting as claimed in claim 8, wherein: the connecting portion is provided to the one side of the first housing portion; and the second housing portion is provided to the opposite side of and/or above the first housing portion.

10. A plumbing fitting as claimed in claim 8, wherein the first housing portion has a circular side wall having at least one perforation to permit water to flow from the bath into the first housing portion.

11. A plumbing fitting as claimed in claim 1, in combination with such a complementary plumbing component.

12. A bath having: a wall formed with an overflow hole; a plumbing component for leading to a waste; and plumbing fitting, the plumbing fitting comprising: a housing having a connecting portion for mating through the overflow hole with a complementary connecting portion of the plumbing component so as to attach the plumbing fitting and plumbing component to the bath and to provide an overflow passageway through the housing into the plumbing component; means for detecting the presence of water in the housing; and means for providing an alarm output in response to such detection.
